(19) United States
(12) Patent Application Publication
(10) Pub. No.: US 2026/0238904 A1
(43) Pub. Date: Aug. 13, 2026

(54) OPTICAL NETWORK UNIT AND REGISTRATION METHOD THEREOF

(71) Applicant: REALTEK SINGAPORE PRIVATE LIMITED, SINGAPORE (SG)

(72) Inventor: MEI-YAO LIN, San Jose, CA (US)

(21) Appl. No.: 19/050,161

(22) Filed: Feb. 11, 2025

(51) Int. Cl. H04Q 11/00

(52) U.S. Cl. CPC H04Q 11/0067; H04Q 2011/0064; H04Q 2011/0081; H04Q 2011/0086; H04Q 2011/0088

(57) ABSTRACT

An optical network unit (ONU) and a registration method thereof are provided. The registration method includes performing through the ONU: determining whether a network parameter configuration message broadcasted by the OLT is received in a standby state; in response to determining that the network parameter configuration message is received, entering a serial number state, starting to time and generating a timing duration; receiving at least one serial number request message from the OLT in the serial number state; transmitting a serial number response message to the OLT upon each receipt of the serial number request message in the serial number state while the timing duration does not exceed a discovery time, and determining whether an identifier allocation message is received; and in response to determining that the identifier allocation message is received while the timing duration does not exceed the discovery time, entering a ranging state.

### FIELD OF THE DISCLOSURE

The present disclosure relates to a network device and method, and more particularly to an optical network unit (ONU) and a registration method thereof.

### BACKGROUND OF THE DISCLOSURE

Passive Optical Network (PON) is a technology that uses optical fibers to deliver network services from a central office (CO) to multiple customers. An optical line termination (OLT) is installed at the CO, while optical network units (ONUs) deployed at the customer premises.

To allow ONUs to join the PON, the OLT broadcasts a serial number grant to ONUs that have not yet been assigned an ONU identification identifier. Any ONU in the serial number state can respond to the serial number grant by sending a serial number ONU physical layer operations and maintenance (PLOAM) message to declare its presence in the optical network system.

If the OLT successfully receives the serial number ONU PLOAM, the OLT issues Assign_ONU-ID to the newly joined ONU for direct ONU-ID allocation. Upon receiving the ONU-ID, the ONU continues the ONU initialization process.

However, when multiple ONUs simultaneously respond to the serial number grant, the OLT may fail to successfully receive the serial number ONU PLOAM message due to response collisions from multiple ONUs, resulting in ONU initialization failure. Conventional ONUs that fail to initialize must return to an initial or standby state before re-entering the serial number state to wait for the next serial number grant, thereby extending the time required to complete the ONU initialization process.

Therefore, reducing the time required for the ONU initialization process to improve registration success rates has become one of the critical issues to be addressed.

### SUMMARY OF THE DISCLOSURE

In response to the above-referenced technical inadequacies, the present disclosure provides an optical network unit (ONU) and a registration method thereof capable of reducing the time required for the ONU to complete an initialization process.

In order to solve the above-mentioned problems, one of the technical aspects adopted by the present disclosure is to provide a registration method of an optical network unit (ONU), the ONU is in communication with an optical line termination (OLT), and the registration method includes the following processes: determining whether a network parameter configuration message broadcasted by the OLT is received in a standby state; in response to determining that the network parameter configuration message is received, entering a serial number state, and generating a timing duration; receiving at least one serial number request message from the OLT in the serial number state; transmitting a serial number response message to the OLT upon each receipt of the serial number request message in the serial number state while the timing duration does not exceed a discovery time, and determining whether an identifier allocation message is received, in which a duration of the discovery time a time interval that allows the ONU to receive at least two sequence request messages in the serial number state; and in response to determining that the identifier allocation message is received while the timing duration does not exceed the discovery time, entering a ranging state.

In order to solve the above-mentioned problems, another one of the technical aspects adopted by the present disclosure is to provide an optical network unit (ONU), which is communicatively connected to an optical line termination (OLT). The ONU includes an ONU media access control (MAC) circuit and a discovery time generation circuit. The ONU MAC circuit is configured to perform the following processes: determining whether a network parameter configuration message broadcasted by the OLT is received in a standby state; in response to determining that the network parameter configuration message is received, entering a serial number state, and generating a timing duration; receiving at least one serial number request message from the OLT in the serial number state; transmitting a serial number response message to the OLT upon each receipt of the serial number request message in the serial number state while the timing duration does not exceed a discovery time, and determining whether an identifier allocation message is received, in which a duration of the discovery time is a time interval that allows the ONU to receive at least two sequence request messages in the serial number state; and in response to determining that the identifier allocation message is received while the timing duration does not exceed the discovery time, entering a ranging state. The discovery time generation circuit is connected to the ONU MAC circuit, and is configured to generate the discovery time, which is provided to the ONU MAC circuit.

Therefore, the ONU and the registration method thereof provided by the present disclosure can dynamically adjust the discovery time in a specific state based on the time characteristics of the serial number grant, which increases the probability of successful ONU registration while reducing the time required for the ONU to complete the initialization process.

Furthermore, in the ONU and the registration method thereof provided by the present disclosure, by evaluating the time characteristics of the serial number request message, the time the ONU remains in the serial number state can be extended, which not only allows the ONU to generate multiple serial number response messages in response to the serial number request message during this period without the need to wait for the time wasted resetting to the initial state or standby state, but also enables the ONU to adapt to OLTs from different vendors or network providers.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a functional block diagram of a passive optical network (PON) system according to one embodiment of the present disclosure;

FIG. 2 is a signal and state timing diagram of an OLT and an ONU in the PON system according to one embodiment of the present disclosure;

FIG. 3 is a detailed block diagram of the PON system shown in FIG. 1;

FIG. 4 is a flowchart of the registration method for the PON system according to the present disclosure; and

FIG. 5 is another signal and state timing diagram of the OLT and ONU in the PON system according to the embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

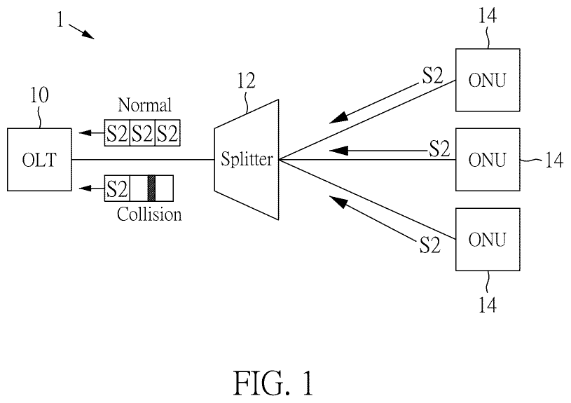

FIG. 1 is a functional block diagram of a passive optical network (PON) system 1 according to one embodiment of the present disclosure. Referring to FIG. 1, the PON system 1 is provided, which includes an optical line termination (OLT) 10, a splitter 12, and a plurality of optical network units (ONUs) 14 provided by the present disclosure.

In the PON system 1, the OLT 10, for example, can be a critical device located at a telecommunications company's network switching center. The main functions of the OLT 10 include data aggregation, optical signal generation, and control management. The OLT 10 collects data from the core network, converts these data signals into optical signals, and transmits the optical signals through optical fibers to the ONUs 14, respectively. The OLT 10 is also responsible for managing and distributing signals to the ONUs 14, including performing traffic management, authorization, and error detection to ensure the efficient operation of the entire optical network.

Specifically, the functions of the OLT 10 include signal conversion, traffic scheduling, control management, and protocol processing. In terms of signal conversion, the OLT 10 is capable of converting electrical signals into optical signals and transmitting them through optical fibers. For traffic scheduling, the OLT 10 allocates upstream and downstream bandwidth to ensure fair competition among different ONUs 14. Regarding control management, the OLT 10 manages the entire PON network, including the registration, configuration, and maintenance of the ONUs 14. In protocol processing, the OLT 10 manages the encapsulation and decapsulation of PON protocols such as GPON and EPON.

The splitter 12 is a passive optical component in the PON system 1 that divides a single optical fiber into multiple optical fibers. The splitter 12 is used to distribute the optical signals sent by the OLT 10 to multiple ONUs 14, enabling one-to-many optical fiber transmission. In some embodiments, the splitter 12 can be, for example, a planar lightwave circuit (PLC) splitter or a fused-fiber splitter. The PLC splitter, based on planar lightwave circuit technology, offers advantages such as high performance and low loss. On the other hand, the fused-fiber splitter joins multiple optical fibers together, offering a more cost-effective solution. In the PON system 1, the ONUs 14 can communicate with the OLT 10 through the splitter 12. In some embodiments, the ONUs 14 can also be directly connected to the OLT 10 without using a splitter.

Additionally, the ONUs 14 provided by the present disclosure can be flexibly distributed across different geographical locations. Each ONU 14 can be installed at the end user's premises, such as in homes or offices. The ONU 14 is responsible for receiving optical signals from the splitter, and converting the optical signals into electrical signals that can be used by the end user. These electrical signals can be connected to the user's terminal devices, such as computers or routers, through various interfaces, such as RJ45 Ethernet interfaces. Additionally, the ONU is responsible for amplifying and decoding signals to ensure that users receive a stable and high-quality data connection.

In the PON system 1, the high-bandwidth optical fibers connecting the OLT 10 and ONU 14 provide low-latency and high-speed data transmission. These optical fibers are designed to support long-distance data transmission, making optical networks particularly well-suited for high-speed transfer of large volumes of data.

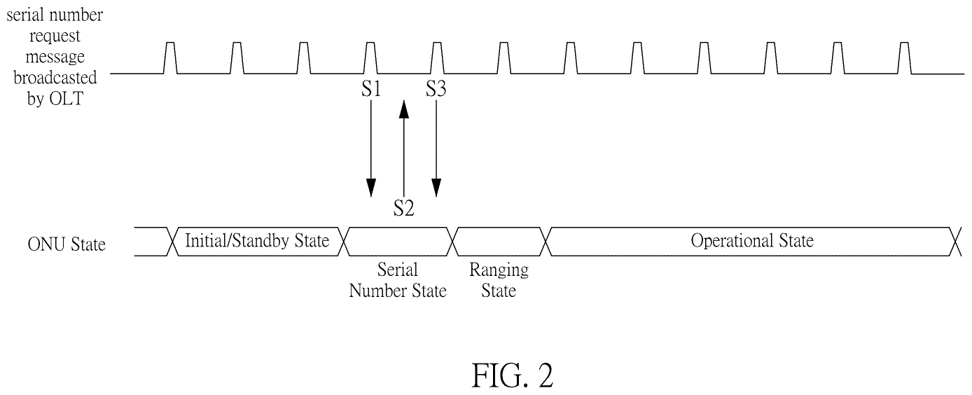

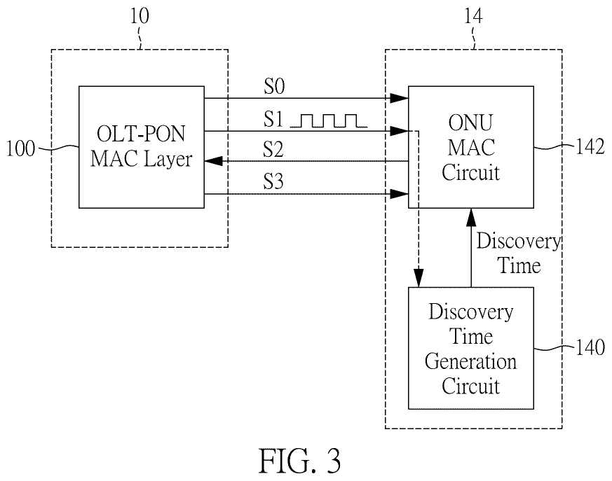

Referring to FIGS. 2 and 3, FIG. 2 is a signal and state timing diagram of an OLT and an ONU in the PON system according to one embodiment of the present disclosure, and FIG. 3 is a detailed block diagram of the PON system shown in FIG. 1. It should be noted that the PON system 1 of the present disclosure is applicable to sections 7 to 10 in the international telecommunication union telecommunication standardization sector (ITU-T) series G: Transmission Systems and Media, Digital Systems, and Networks. Specifically, it aligns with version 984.3 (referred to as ITU-T G.983), sections C.6, C.8, and C.10 to C.12 in ITU-T G.9807.1, and sections 6, 8, 10, 11, and 12 of ITU-T G.9804.2. As certain parts of the PON system 1 adopt the architecture specified in these standards, only the key features are described in the embodiments of the present disclosure.

When the ONU operates in different states, such as an initialization state, a standby state, a serial number state, a ranging state, and an operational state, the ONU interacts with the OLT in different ways. In the initial state, the ONU has just been powered on and started. At this stage, the ONU establishes an initial connection with the OLT. The ONU performs a self-check to ensure that its internal modules are functioning properly.

In the standby state, the ONU waits for global network parameters provided by the OLT. Once the ONU receives the Upstream_Overhead message from the OLT, the ONU configures itself based on these network parameters, such as delimiter values, power level modes, and pre-assigned delays, and then transitions to the serial number state.

When the ONU enters the serial number state, the ONU exchanges multiple messages with the OLT. Initially, the OLT continuously broadcasts periodic serial number request messages S1 (e.g., a serial number request bandwidth map (BWmap) allocation) to all ONUs on the optical fiber line. Upon receiving the serial number request message S1, the ONU responds with a serial number response message S2 (e.g., a serial number ONU message) to notify the OLT of presence of the ONU and confirm an authorization status of the ONU. After the ONU responds, the ONU waits for the OLT 10 to assign a unique ONU-ID. This ONU-ID is assigned through an identifier allocation message (e.g., Assign_ONU-ID message) S3 sent by the OLT 10. When the ONU receives the Assign_ONU-ID message, the ONU transitions to the ranging state. However, as shown in FIG. 1, the serial number response messages S2 from different ONUs may collide, causing the OLT 10 to fail to process them in time and thus unable to assign ONU-IDs to some ONUs 14 that have sent serial number response messages S2.

In the ranging state, the OLT 10 and the ONU 14 perform synchronized ranging to determine a physical distance therebetween. This is accomplished by sending specific ranging signals. The OLT 10 sends ranging commands to the ONU 14, which responds to these signals upon reception. Based on the transmission and return times of the signals, the OLT 10 calculates the distance to the ONU 14. This helps adjust the transmission timing of the signals to ensure accurate data delivery within the network.

More specifically, upstream transmissions from different ONUs 14 must be synchronized with the upstream gigabit PON transmission convergence (GTC) frame boundaries. In order to make the ONU 14 appears to be at an equal distance from the OLT 10, an equalization delay per ONU is required. This equalization delay is measured while the ONU 14 is in the ranging state. Once the ONU receives the Ranging_Time message, it moves to the operation state.

In the operational state, the interaction between the ONU 14 and the OLT 10 transitions into the normal data transmission phase. At this stage, the ONU 14 receives and forwards data from the OLT 10 while simultaneously transmitting user data back to the OLT 10. This includes both upstream and downstream data flows, ensuring the proper functioning of the optical network services. In this state, the ONU 14 and the OLT 10 continuously monitor the network's status, performing traffic management and error detection to maintain network efficiency and stability.

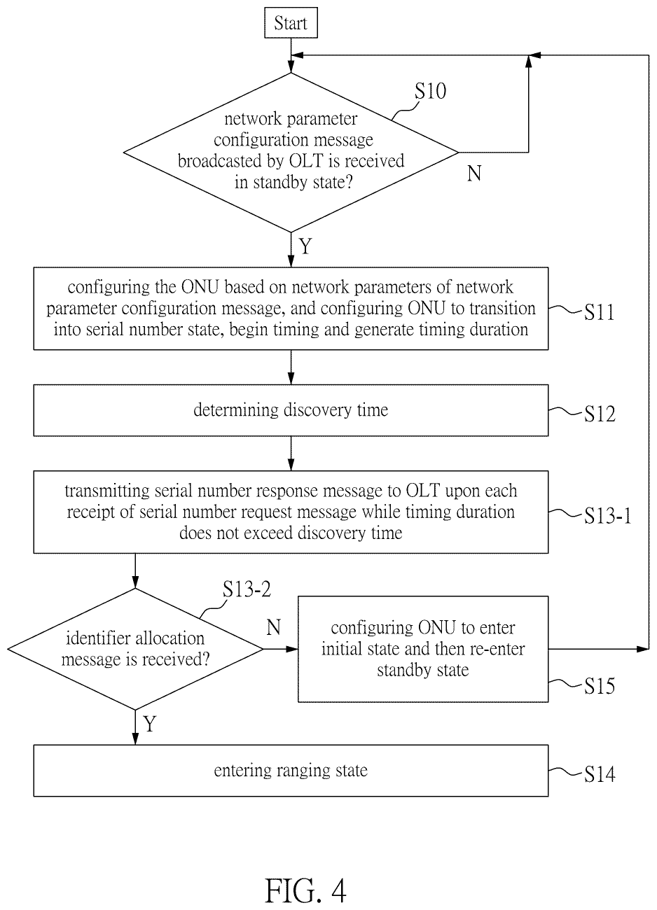

FIG. 4 is a flowchart of the registration method for the PON system according to the present disclosure. It should be noted that the registration method of the ONU provided by the present disclosure is explained with reference to FIGS. 3 and 4. In FIG. 3, only essential components involved in the registration method are shown, and the present disclosure is not limited thereto. For example, each ONU 14 can include a discovery time generation circuit 140 and an ONU media access control (MAC) circuit 142. The ONU MAC circuit 142 is further connected to the OLT-PON MAC layer 100 of the OLT 10. The ONU MAC circuit 142 and the discovery time generation circuit 140 can, for instance, include processors or logic circuits capable of implementing the functions of the ONU MAC circuit 142 and the discovery time generation circuit 140.

As shown in FIG. 4, the present disclosure provides a registration method of the ONU, which includes, after multiple ONUs 14 are communicatively connected to the OLT 10 as illustrated in FIGS. 1 and 3, configuring each ONU 14 to perform the following steps (e.g., through the ONU MAC circuit 142):
Step S10: determining whether a network parameter configuration message broadcasted by the OLT is received in a standby state. As described above, the network parameter configuration message S0 can, for example, be the Upstream_Overhead message provided by the OLT, as mentioned in the standard.

In response to determining that the ONU receives the network parameter configuration message S0 (e.g., the Upstream_Overhead message), the registration method proceeds to step S11: configuring the ONU based on multiple network parameters of the network parameter configuration message, and configuring the ONU to transition into the serial number state, begin timing and generate a timing duration. If the network parameter configuration message S0 is not received in step S10, step S10 is repeated.

It should also be noted that the OLT 10 periodically broadcasts the serial number request message S1. In this way, the OLT 10 can detect newly appeared or disappeared ONUs on the optical fiber line and assign an ONU identifier (ONU-ID) to each newly appeared ONU.
Step S12: determining a discovery time.

For example, the discovery time can be determined based on a time characteristic of the serial number request message S1. In this embodiment, in response to the ONU receiving at least one serial number request message S1, the discovery time in the serial number state is set according to the time characteristic of the serial number request message S1. In this step, when the ONU MAC circuit 142 receives the serial number request message S1, the ONU MAC circuit 142 analyzes the message to determine the time characteristic of the serial number request message S1. The time characteristic is used to decide the total time the ONU remains in the serial number state, thereby setting the discovery time mentioned above. Ater the discovery time generation circuit 140 generates the discovery time, the discovery time can be provided to the ONU MAC circuit 142.

For example, the time characteristic can include a duration of each serial number request message S1 and/or a transmission cycle of the serial number request message S1. It should be noted that the discovery time is not less than twice the transmission cycle of the serial number request message. In other words, the discovery time allows for the reception of at least two serial number request messages. In some embodiments, the discovery time is set based on the time characteristic of the serial number request message. For instance, the discovery time can fall within a discovery time range defined by a maximum discovery time and a minimum discovery time. For example, in the existing Gigabit/10 Gigabit passive optical networks (G/XG-PON) transmission convergence layer specifications, a serial number acquisition and ranging timer, also referred to as a TO1 timer, is defined for the serial number state and the ranging state. This timer is used to limit the total time an ONU remains in these states, thereby terminating unsuccessful initialization attempts. For the above specification, the minimum discovery time must exceed a preset time limit, allowing the ONU 14 to remain in the serial number state for a longer period, which enables the ONU 14 to generate multiple serial number response messages S2 during this period to respond to the serial number request message S1.

In some embodiments, the discovery time generation circuit 140 can include a counter. The counter is used to count the number of the serial number request messages S1 received. When the count reaches a predetermined number (at least twice), the discovery time generation circuit 140 issues an interrupt to the ONU MAC circuit 142 to serve as an end of the discovery time.

It is worth noting that different vendors or network providers may adopt various dynamic bandwidth allocation algorithms and characteristics for the intervals that utilized for discovering ONUs and issuing serial number grant (i.e., serial number request messages S1). By evaluating the time characteristic of the serial number request messages S1, the present disclosure enables the ONU 14 to adapt to OLTs 10 from different vendors or network providers.

Additionally, in step S12, a length of the discovery time can be determined through various methods. For example, the user can determine an experimental time interval for the current PON system 1 by conducting experiments to allow the ONU 14 to respond to a predetermined number of the serial number request messages S1 with a corresponding number of the serial number response messages S2. The experimental time interval can then be used to set the length of the discovery time. In such cases, the discovery time is set as a fixed time interval rather than being set based on the time characteristic of the serial number request messages S1.

Similarly, the maximum discovery time can also be determined experimentally to establish an appropriate upper limit, which prevents the ONU 14 from waiting excessively long time during abnormal system conditions, ensuring that the ONU 14 can reset to the initial state or the standby state timely.
Step S13-1: transmitting a serial number response message to the OLT upon each receipt of the serial number request message while the timing duration does not exceed a discovery time. The registration method then proceeds to step S13-2: determining whether an identifier allocation message is received.

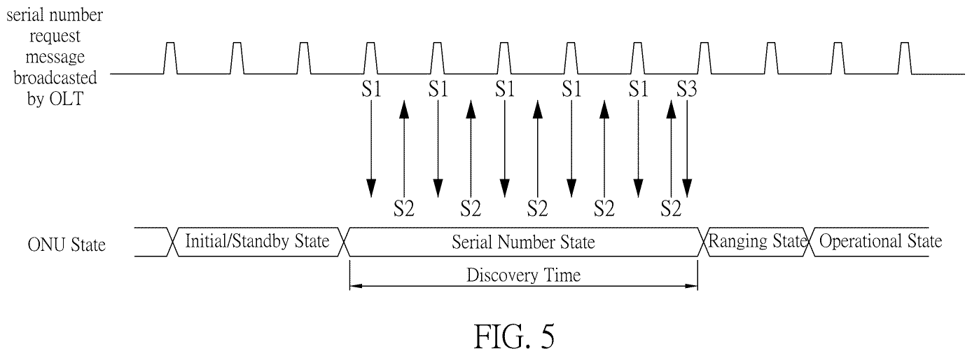

Therefore, reference is made to FIG. 5, and FIG. 5 is another signal and state timing diagram of the OLT and ONU in the PON system according to the embodiment of the present disclosure. In FIG. 5, a predetermined number can be five. In other words, before the timing duration exceeds the set discovery time, the ONU can send up to five serial number response messages S2 to the OLT 10 upon receiving serial number request messages. This continues until the identifier allocation message S3 is received or the timing duration exceeds the discovery time. As shown in FIG. 5, it is evident that after the first four attempts to send serial number response messages S2 to the OLT 10, no identifier allocation message S3 is returned by the OLT 10, which indicates that the serial number response messages S2 may have collided with those from other ONUs 14, preventing the OLT 10 from assigning an ONU-ID promptly. After the fifth attempt to send the serial number response message S2, the ONU 14 successfully receives the identifier allocation message S3 returned by the OLT 10.

In response to determining that the identifier allocation message S3 is received before the timing duration exceeds the discovery time, the registration method proceeds to step S14: entering the ranging state.

In response to determining that the identifier allocation message S3 is not received before the timing duration exceeds the discovery time, the registration method proceeds to step S15: configuring the ONU to enter the initial state and then re-enter the standby state. The registration method returns to step S10.

It should be noted that the ONU MAC circuit 142 can be used to receive and send various physical layer operations and maintenance (PLOAM) messages, including the aforementioned network parameter configuration message S0, the serial number request message S1, the serial number response message S2, and the identifier allocation message S3.

Once the ranging state is completed, the ONU 14 is successfully registered by the OLT 10. The ONU 14 then transitions to the operational state, enabling normal data transmission interactions between the ONU 14 and the OLT 10.

### Beneficial Effects of the Embodiments

In conclusion, the ONU and the registration method thereof provided by the present disclosure can dynamically adjust the discovery time in a specific state based on the time characteristics of the serial number grant, which increases the probability of successful ONU registration while reducing the time required for the ONU to complete the initialization process.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A registration method of an optical network unit (ONU), the ONU being in communication with an optical line termination (OLT), the registration method comprising the following processes:
determining whether a network parameter configuration message broadcasted by the OLT is received in a standby state;
in response to determining that the network parameter configuration message is received, entering a serial number state, and generating a timing duration;
receiving at least one serial number request message from the OLT in the serial number state;
transmitting a serial number response message to the OLT upon each receipt of the serial number request message in the serial number state while the timing duration does not exceed a discovery time, and determining whether an identifier allocation message is received, wherein a duration of the discovery time is a time interval that allows the ONU to receive at least two sequence request messages in the serial number state; and
in response to determining that the identifier allocation message is received while the timing duration does not exceed the discovery time, entering a ranging state.

2. The registration method according to claim 1, wherein the discovery time is set based on a time characteristic of the at least one serial number request message.

3. The registration method according to claim 1, wherein the OLT periodically broadcasts the at least one sequence number request message.

4. The registration method according to claim 1, wherein the time characteristic includes a duration of the serial number request message and a transmission cycle.

5. The registration method according to claim 1, wherein the discovery time falls within a discovery time range defined by a maximum discovery time and a minimum discovery time, and the minimum discovery time is at least greater than a preset time limit of a serial number acquisition and ranging timer in a transmission convergence layer specification of gigabit/10 gigabit passive optical networks (G/XG-PON).

6. The registration method according to claim 4, wherein the discovery time is greater than or equal to the transmission cycle plus the duration, multiplied by a predetermined quantity.

7. The registration method according to claim 1, wherein the OLT is configured to assign an ONU identifier upon receiving any of the serial number response message, and incorporate the ONU identifier into the identifier allocation message, and transmits the identifier allocation message to the corresponding ONU.

8. The registration method according to claim 1, wherein, in response to not receiving the identifier allocation message after the timing duration exceeds the discovery time, the OLT re-enters the standby state.

9. The registration method according to claim 1, wherein the discovery time is not less than twice a transmission cycle of the at least one serial number request message.

10. An optical network unit (ONU), communicatively connected to an optical line termination (OLT), the ONU comprising:
an ONU media access control (MAC) circuit configured to perform the following processes:
determining whether a network parameter configuration message broadcasted by the OLT is received in a standby state;
in response to determining that the network parameter configuration message is received, entering a serial number state, and generating a timing duration;
receiving at least one serial number request message from the OLT in the serial number state;
transmitting a serial number response message to the OLT upon each receipt of the serial number request message in the serial number state while the timing duration does not exceed a discovery time, and determining whether an identifier allocation message is received, wherein a duration of the discovery time is a time interval that allows the ONU to receive at least two sequence request messages in the serial number state; and
in response to determining that the identifier allocation message is received while the timing duration does not exceed the discovery time, entering a ranging state; and
a discovery time generation circuit connected to the ONU MAC circuit, wherein the discovery time generation circuit is configured to generate the discovery time, which is provided to the ONU MAC circuit.

11. The ONU according to claim 10, wherein the discovery time is set based on a time characteristic of the at least one serial number request message.

12. The ONU according to claim 10, wherein the discovery time generation circuit is configured to receive the at least one serial number request message and set the discovery time based on a time characteristic of the at least one serial number request message.

13. The ONU according to claim 10, wherein the OLT is configured to periodically broadcast a plurality of the serial number request messages.

14. The ONU according to claim 10, wherein the time characteristic includes a duration of each of the plurality of serial number request messages and a transmission cycle.

15. The ONU according to claim 10, wherein the discovery time falls within a discovery time range defined by a maximum discovery time and a minimum discovery time, and the minimum discovery time is at least greater than a preset time limit of a serial number acquisition and ranging timer in a transmission convergence layer specification of gigabit/10 gigabit passive optical networks (G/XG-PON).

16. The ONU according to claim 14, wherein the discovery time is greater than or equal to the transmission cycle plus the duration, multiplied by a predetermined quantity.

17. The ONU according to claim 10, wherein the identifier allocation message further includes an ONU identifier assigned by the OLT upon receiving the serial number response message.

18. The ONU according to claim 10, wherein the ONU MAC circuit is further configured to perform the following processes:
when the timing duration does not exceed the discovery time, repeatedly sending the serial number response message to the OLT upon receiving the serial number request message, until either the identifier allocation message is received or the timing duration exceeds the discovery time.

19. The ONU according to claim 10, wherein the ONU MAC circuit is further configured to perform following processes:
in response to not receiving the identifier allocation message after the timing duration exceeds the discovery time, entering an initial state and then re-entering the standby state.

20. The ONU according to claim 10, wherein the discovery time is not less than twice a transmission cycle of the at least one serial number request message.
